(19) United States
(12) Patent Application Publication
(10) Pub. No.: US 2008/0256563 A1
(43) Pub. Date: Oct. 16, 2008

(54) SYSTEMS AND METHODS FOR USING A LODESTONE IN APPLICATION WINDOWS TO INSERT MEDIA CONTENT

(76) Inventor: Cheng HAN, Lexington, MA (US)

Correspondence Address: CHOATE, HALL & STEWART LLP, TWO INTERNATIONAL PLACE, BOSTON, MA, 02110, US

(21) Appl. No.: 11/735,259

(22) Filed: Apr. 13, 2007

(51) Int. Cl. G06F 9/46; G06F 15/00

(52) U.S. Cl. 719/329

(57) ABSTRACT

Lightweight application components are provided which can be displayed in a number of unaffiliated application windows and allow a user to insert media content into the application windows. In some embodiments, the present invention may comprise a lodestone application which allows a user to insert media files and/or links to media files in e-mails, instant messages, and other communications. In one embodiment, a method for displaying a lodestone includes: receiving, via an operating system, a window event; determining the window event indicates activation of an application window; determining the application window corresponds to an application window for which a lodestone is configured; identifying, in response to the determinations, display configuration information for the lodestone, the display configuration information corresponding to the application window; and displaying, according to the display configuration information, the lodestone in the application window.

### BACKGROUND OF THE INVENTION

Many people use a computer to create, edit, and share media content among other users. A user may wish to distribute videos, songs, commercials, photos, and any other type of media to friends. For example, a user may wish to send a clip of a family video the user has just watched to a number of friends.

A computer user may use a number of different applications for communicating with other computer users, such as e-mail, instant messaging, videoconferencing, VoIP telephony. Many of these applications may comprise functionality for transmitting media files or links to media files. One common approach is for users to copy a link (URL) of a central server location and send text messages including the link via their preferred communication channels. However, it may be inconvenient for a user to move a media file or copy a link from a media application into a communication application. Further, different communication applications may use different formats and have different capabilities for sending data.

Thus, there exists a need for allowing a user to easily incorporate media content into a number of unaffiliated communication applications.

### SUMMARY OF THE INVENTION

The present invention may be used to provide lightweight application components which can be displayed in a number of unaffiliated application windows and allow a user to insert media content into the application windows. In some embodiments, the present invention may comprise a lodestone application which allows a user to insert media files and/or links to media files in e-mails, instant messages, and other communications.

In one aspect, the present invention includes methods for displaying a lodestone application to integrate functionality of a media application in a plurality of unaffiliated application windows. In one embodiment, a method includes: receiving, via an operating system, a window event; determining the window event indicates activation of an application window; determining the application window corresponds to an application window for which a lodestone is configured; identifying, in response to the determinations, display configuration information for the lodestone, the display configuration information corresponding to the application window; and displaying, according to the display configuration information, the lodestone in the application window.

In another aspect, the present invention includes computer implemented systems for displaying a lodestone application to integrate functionality of a media application in a plurality of unaffiliated application windows. In one embodiment, a system comprises: means for receiving, via an operating system, a window event; means for determining the window event indicates activation of an application window; means for determining the window event corresponds to an application window for which a lodestone is configured; means for identifying, in response to the determinations, display configuration information for the lodestone, the display configuration information corresponding to the application window; and means for displaying, according to the display configuration information, the lodestone in the application window.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram of an example of a lodestone being displayed in a plurality of application windows;

FIGS. 2A and 2B are block diagrams of example computing devices;

FIG. 3A is a block diagram of an example of using a lodestone to insert media content into a second application;

FIG. 3B is a flow diagram of one embodiment of a method for displaying a lodestone application to integrate functionality of a media application in a plurality of unaffiliated application windows;

FIG. 4 is a diagram of an example network which may be used to distribute media files in conjunction with a lodestone application

FIG. 5 is a block diagram of an example media application which may be used in conjunction with a lodestone application.

### DETAILED DESCRIPTION

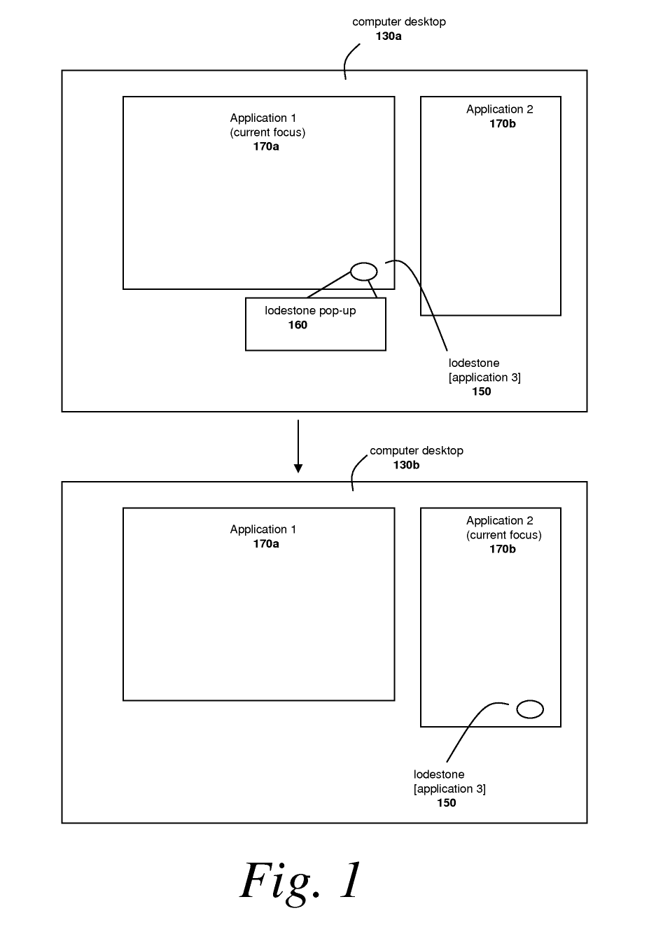

Referring now to FIG. 1, a block diagram of an embodiment of a lodestone application is shown. In brief overview, a computer desktop 130a, 130b (generally 130) may comprise a number of executing applications 170a, 170b (generally 170). A lodestone 150 corresponding to a second application may be displayed in the window of an application currently selected by a user. The lodestone 150 may allow a user to access functionality or content from the second application in the context of the current application window. In some embodiments, a lodestone 150 may display a lodestone pop-up 160 for further access to functionality and/or content of the second application.

Still referring to FIG. 1, now in greater detail, a lodestone 150 may be used to access functionality or content from a second application in the context of a currently selected application window. A lodestone may comprise any graphical interface or indication displayed inside an application window which is displayed by an application other than the application responsible for the application window. For example, a media player application may display a lodestone in an instant messenger window. The lodestone may provide functionality for a user to send a link or a recently viewed media file via the instant messenger window. Or, for example, a media player application may display a lodestone in an e-mail window, which allows a user to easily e-mail one or more people information about a video the user has just created.

In the embodiment shown, a lodestone 150 allows a user to access function from an application (application 3, not shown) from a number of other application windows 170. As an application window becomes active, a lodestone is displayed in the application window by a process which may operate in conjunction with application 3. The process displaying the lodestone may be completely separate from one or more processes or applications responsible for the display of the application window 170. In one embodiment, a process may receive window events from an operating system and, based on the received events, display a lodestone in the currently active application window. The process may also cease displaying of any lodestones in windows which are not currently selected by a user.

A lodestone may comprise any graphical indication including, without limitation, an icon, image, text, link, or pop-up window. For example, in the embodiment shown, the lodestone 150 may comprise an oval icon which triggers display of a pop-up window 160 upon a user interaction with the lodestone. In other embodiments, a lodestone may alter its own display in response to user interactions. For example, the lodestone may change color, shape, or size in response to a user moving a cursor over the lodestone.

A lodestone may provide any means for user interaction with the lodestone including, without limitation, a user clicking on a lodestone, moving a cursor over a lodestone, hovering a cursor over a lodestone, or a user entering a designated keystroke or keystrokes. In some embodiments, a lodestone may comprise multiple components. In one embodiment, a lodestone may comprise a plurality of grouped graphical icons. Each graphical icon may allow the user to perform a different function with respect to a lodestone. For example, a user clicking on a first icon in a group might paste text from another application into the current application window, while clicking on a second icon in the group might cause a pop-up window 160 to be displayed.

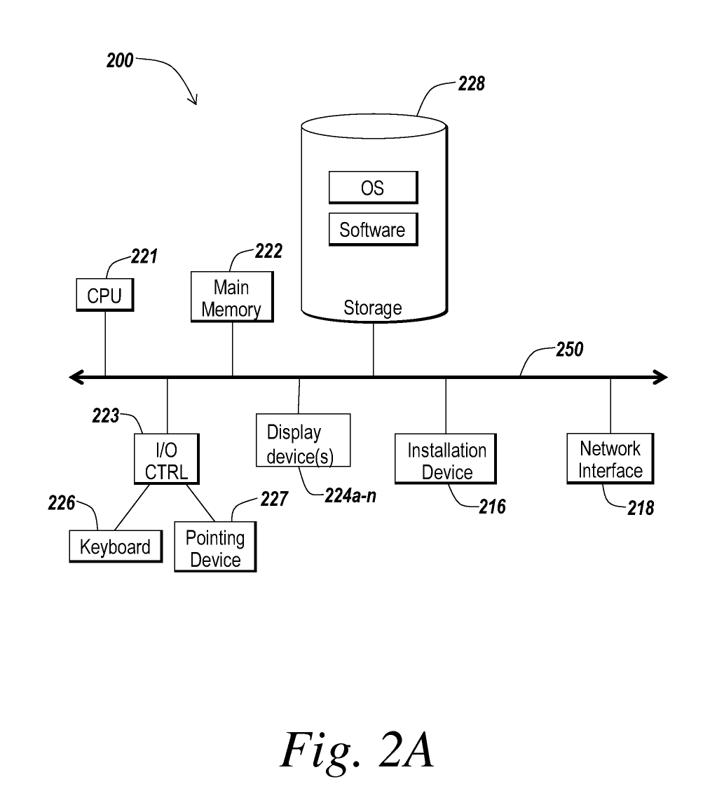

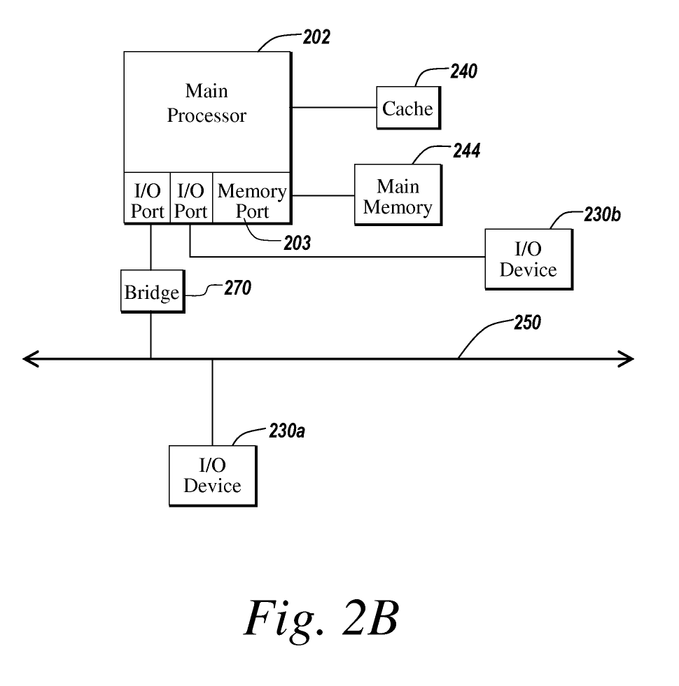

FIGS. 2A and 2B depict block diagrams of a typical computer 200 useful as a computing device for executing and displaying a lodestone and/or performing any other functions described herein. As shown in FIGS. 2A and 2B, each computer 200 includes a central processing unit 202, and a main memory unit 204. Each computer 200 may also include other optional elements, such as one or more input/output devices 230a-230b (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 2A, the processor 202 communicates with main memory 204 via a system bus 250 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 250. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 250. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, cameras, video cameras, microphones, and drawing tablets. Output devices include video displays, speakers, inkjet printers, laser printers, and dye-sublimation printers. An I/O device may also provide mass storage for the computer system 800 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 250 and an external communication bus, such as a USB bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose computers of the sort depicted in FIG. 2A and FIG. 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

For embodiments comprising mobile devices, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. In other embodiments comprising mobile devices, a mobile device may be a personal digital assistant (PDA) operating under control of the PalmOS operating system, such as the Tungsten W, the VII, the VIIx, the i705, all of which are manufactured by palmOne, Inc. of Milpitas, California. In further embodiments, the client 113 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, California; or the Toshiba PocketPC e405, manufactured by Toshiba America, Inc. of New York, N.Y. In still other embodiments, the mobile device is a combination PDA/telephone device such as the Treo 180, Treo 270, Treo 600, Treo 650, Treo 700, or the Treo 700w, all of which are manufactured by palmOne, Inc. of Milpitas, Calif. In still further embodiments, the mobile device is a cellular telephone that operates under control of the PocketPC operating system, such as the MPx200, manufactured by Motorola Corp. In still other embodiments, a mobile device may comprise a mobile gaming device with wireless communication capability. A typical mobile device may comprise many of the elements described above in FIGS. 2A and 2B, including the processor 202 and the main memory 204.

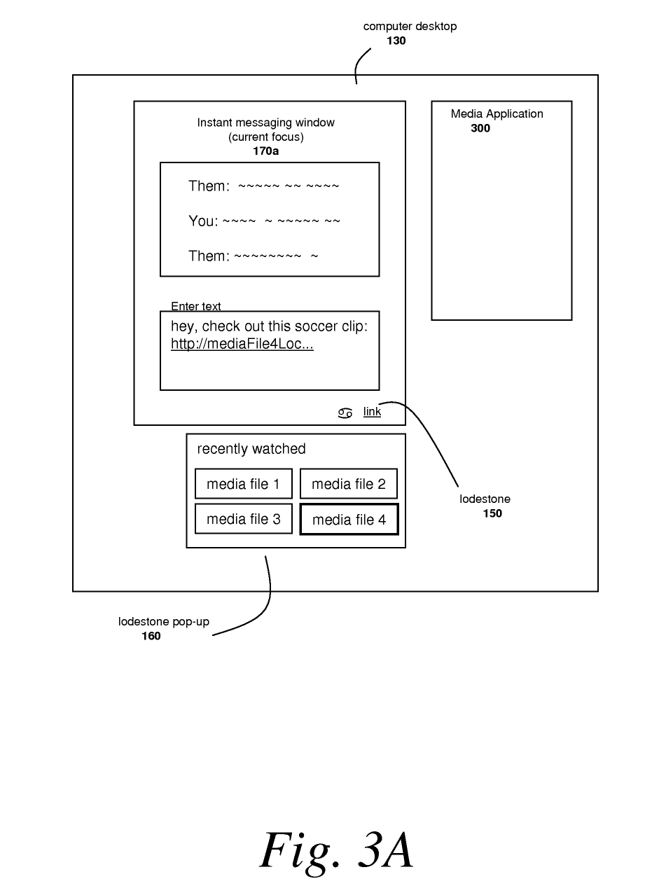

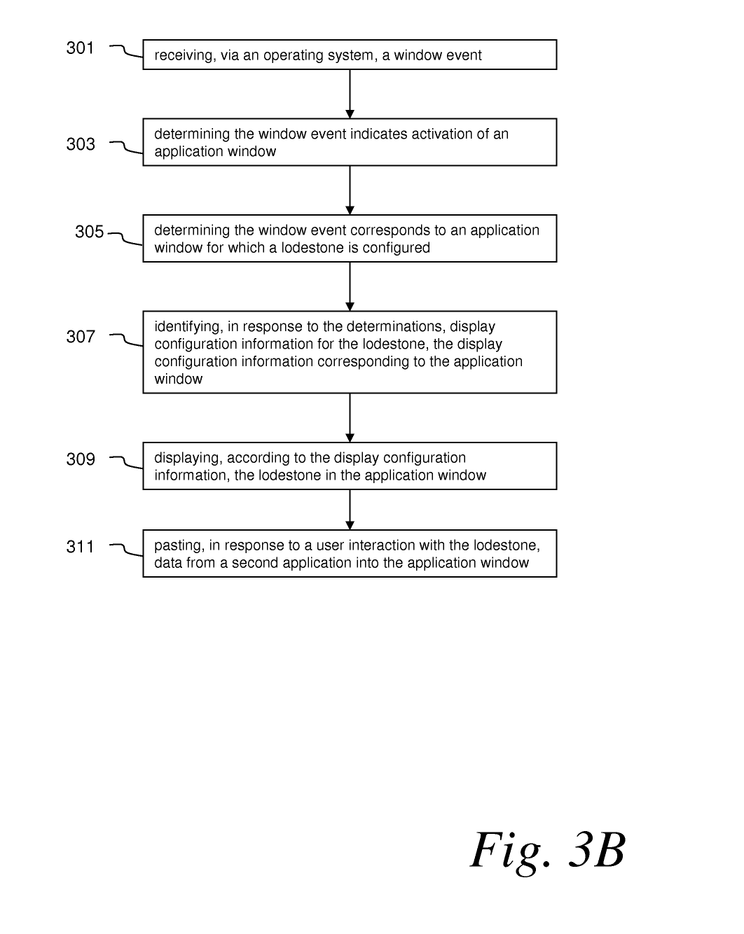

Referring now to FIGS. 3A and 3B, FIG. 3A shows a method for displaying a lodestone application, while FIG. 3B shows an example of a lodestone application used in conjunction with an instant messaging window. In brief overview, a method for displaying a lodestone application to integrate functionality of a media application in a plurality of unaffiliated application windows may comprise: receiving, via an operating system, a window event (step 301); determining the window event indicates activation of an application (step 303); determining the window event corresponds to an application window for which a lodestone is configured (step 305); identifying, in response to the determinations, display configuration information for the lodestone, the display configuration information corresponding to the application window (step 307); displaying, according to the display configuration information, the lodestone in the application window (step 309); and pasting, in response to a user interaction with the lodestone, data from a second application into the application window (step 311).

Still referring to FIGS. 3A and 3B, now in greater detail, a method for displaying a lodestone application may comprise a lodestone application receiving, via an operating system, a window event (step 301). Within the context of this specification and the claims, “lodestone application” refers to any application(s), process(es), daemon(s), executable instruction(s) or any combinations thereof which control display of a lodestone. A “lodestone” refers to the graphical component displayed in an application window by a lodestone application. A lodestone application may receive the window event in any manner. In some embodiments, a lodestone application may register to receive window events from an operating system. In one embodiment, a lodestone application may register to receive only a subset of window events. For example, a lodestone application may register to receive events corresponding to one or more of window closing, window opening, window activation, window deactivation, window move, and window resize events. In one example, a lodestone application executing in a MICROSOFT WINDOWS environment may register a hook message container which receives WM_ACTIVE events. A lodestone application may employ a timer to periodically check whether a window event has been received.

A lodestone application may determine a window event indicates activation of an application window in any manner (step 303). In one embodiment, a lodestone may determine whether a window event corresponds to one or more of a window closing, window opening, window activation, window deactivation, window move, and window resize events. In another embodiment, a lodestone may determine whether a window event corresponds to a WM_ACTIVE event. A lodestone application may use any other information in combination with, or in place of, a window event to determine a currently active window including, without limitation, mouse click events, mouse press events, mouse release events, mouse over events, mouse off events, keystroke events, or any combination thereof.

A lodestone application may determine a window event corresponds to an application window for which a lodestone is configured in any manner (step 305) In some embodiments, a lodestone application may identify a class corresponding to a currently active window. In one embodiment, a lodestone application may identify whether the application window is a dialog box, toolbar, or other specialized type of application window. In other embodiments, a lodestone application may also determine a process name and/or an application name corresponding to the window event. For example, a lodestone application may identify the process name corresponding to the application window as “emailClient.exe”, and consult a table of process to determine whether “emailClient.exe” is a component of an application for which a lodestone is configured. The lodestone application may identify the compiled class name of an application window and check the class name against a table of known class names for alert boxes to determine whether the window is an e-mail composing window, or simply an alert window (such as, for example, a pop-up alerting the user his e-mail quota is exceeded). If “emailClient.exe” is an application for which a lodestone is configured, and the class name corresponds to a window class for which the lodestone is configured, the lodestone application may then display a lodestone in the window class, and cease display of any other lodestones currently being displayed.

A lodestone may be configured to be displayed in any application windows. Examples of application windows that a lodestone may be displayed in include, without limitation, instant messaging windows, e-mail windows, internet browsers, word processors, spreadsheets, web page design applications, and media file player applications.

A lodestone application may be configured for any number and any type of application windows, and may be configured for any number and type of applications. In some embodiments, a lodestone application may maintain a list or table of applications and/or application windows for which lodestones are configured. In one embodiment, a lodestone application may maintain or use an XML file comprising information relating to the application windows for which a lodestone application is configured. For example, an XML file may list a number of applications for which a lodestone is configured, along with window class names and process names corresponding to the applications. An XML file may also comprise any information relating to the display of a lodestone within a given application.

In some embodiments, a configuration file for a lodestone application may be updated remotely. In one embodiment, a remote update may occur, or only occur, in response to a user request. For example, an XML file containing class names and process names of applications for which a lodestone is configured may be updated remotely to include additional process names. In other embodiments, a configuration file for a lodestone application may be updated locally. For example, an XML file containing class names and process names of applications for which a lodestone is configured may be updated by a user who adds or removes an application the user does not want a lodestone displayed in. Local configuration may be done by any means including, without limitation, using a GUI, editing a file, or using a command-line interface.

A lodestone application may identify display configuration information for a lodestone in any manner, the display configuration information corresponding to an application window (step 307). In some embodiments, the lodestone application may read the display configuration information from a file. In one embodiment, the lodestone application may read the display configuration information from an XML file. In another embodiment, the lodestone application may dynamically determine some or all of the display configuration information. For example, one or more of the color, shape or size of the lodestone display may be dynamically determined in response to a color or size of the application window.

Display configuration information may comprise any information relating to graphical properties of a lodestone to be displayed. Graphical properties that may be configured include, without limitation, lodestone size, shape, color, transparency, and location (coordinates) within the targeted application window.

In some embodiments, a lodestone may be displayed in an identical manner across a number of application windows. In one embodiment, a lodestone may be displayed in an identical manner for all applications windows. In other embodiments, a lodestone display may be uniquely adapted for one or more application windows. For example, a lodestone may be displayed in the bottom right corner of an instant messenger application window, while a lodestone may be displayed in the bottom left corner of an e-mail composition window.

In some embodiments, a portion of a lodestone may be displayed in the same color as the window in which it is displayed. This may give the lodestone an appearance of being integrated into the application window. For example, prior to displaying a lodestone in an application window, a lodestone application may determine the current color of the area of the window in which the lodestone will be displayed. The lodestone application may then display the canvas background to match the current color.

In some embodiments, a lodestone application may also identify display configuration information for one or more lodestone pop-ups 160. In some embodiments, the lodestone application may determine whether a lodestone pop-up should be included with a particular application window. In other embodiments, any graphical property of the lodestone pop up may be configured including, without limitation, size, shape, color, transparency, and location within or externally to the window.

For example, in FIG. 3A, a lodestone application may determine that for the particular instant messenger window 170a shown, a lodestone 150 should be displayed comprising both a logo character and a text link. In this example, clicking or moving the mouse over the logo character may activate the lodestone pop-up 160, while clicking on the link may paste a URL corresponding to a recently accessed media file into the instant messenger window. In this example, the lodestone application may be operating in conjunction with a media application 300, which allows a user to access and view media files.

An example excerpt of a file configuring a lodestone for display with a particular application is given below.

| | |
|---|---|
| Bgcopy=1 | //Bgcopy whether to copy background and then display image |
| Alpha=30; | //transparency 0–100 |
| Num=5 | //numbers of attached windows |

1=mainwindowclassname $ firstchildwindowclassname[optional] $
secondchildwindowclassname[optional] $
imagepath[optional]$Aimwindowclassname[optional]$ clipansi $ rcpos $
align
mainwindowclassname : //main window class
firstchildwindowclassname: //first child window class (optional)
secondchildwindowclassname: //second child window class (optional),
the above information can be used to identify targeted windows
Imagepath: //name of displayed image (optional)
clipansi: //whether the text in clipboard is Unicode or
ASCII,0:unicode 1:ANSI
rcpos //rectangular coordinates for position of the display
align applignment:0 //When the number =0, rcpos is upper left, when
the number =1 1rcpos is upper right , when the number =2 repos is lower
right, when the number =3, repos is lower left.

A lodestone application may display, according to display configuration information, a lodestone in an application window in any manner (step 309). A lodestone may comprise any graphical indication including, without limitation, an icon, image, text, link, pop-up window, or any combination thereof. A lodestone may be displayed in any portion or portions of an application window including, without limitation, a bottom left corner, bottom right corner, top right corner, top left corner, bottom center, right center, left center, and top center portion of an application window. In some embodiments, a lodestone may be displayed such that the lodestone does not obscure functional portions of an application window. For example, a lodestone may be displayed in unused space in a border of an application window. Or for example, a lodestone may be displayed in an empty portion of a menu or toolbar of an application window.

In some embodiments, upon displaying a lodestone in a first application window, a lodestone application may cease displaying a lodestone in a second application window. By only displaying a lodestone in the currently active application window, a lodestone application may continually provide a user with access to lodestone functionality while minimizing system and display overhead.

A lodestone application may detect any events with respect to a displayed lodestone including, without limitation, a user clicking on a lodestone, moving a cursor over a lodestone, hovering a cursor over a lodestone, or a user entering a designated keystroke or keystrokes.

In some embodiments, a lodestone may allow a user to paste data from an application into the current window (step 311). Examples of data that may be pasted include, without limitation, text, URLs, audio files, video files, photos, and executable files. In one embodiment, a user may also be able to specify a text, graphic, sound, or other message to accompany the data.

In some embodiments, the format the data is pasted in may be determined depending on the current application window. The format may be determined in any manner including, without limitation, detecting a style sheet, paragraph format, font, font size, or font color corresponding to the application window.

In other embodiments, the type of data pasted may be determined depending on the current application window. For example, a media file may be pasted as either a hyperlink to a location of the media file or the media file itself, depending on whether the application supports inclusion of media files. In other examples, a lodestone application may stream a sequence of data via an application window. For example, if a user activates a lodestone displayed in a VoIP application window and selects an audio file, the lodestone may stream the audio file via the VoIP application.

In one embodiments, a lodestone may be configured to operate in a “one-click” mode, where a single click on a lodestone causes a given function to be performed. For example, rather than a user clicking on a lodestone and then being presented with a list of recent pictures viewed to paste into the application window, a lodestone may be configured to always paste the most recently viewed photo into the current application in response to a click. Or for example, an application operating in conjunction with the lodestone application may allow a user to configure or specify an action or piece of data that will be utilized in response to the user clicking on a lodestone.

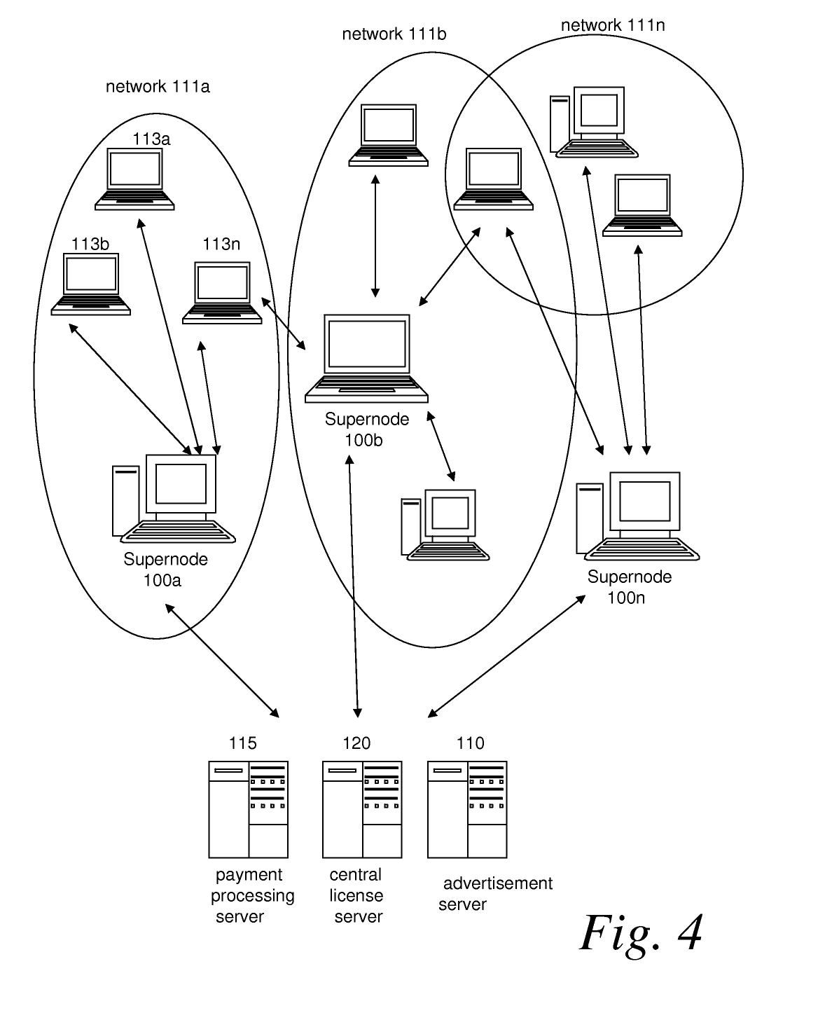

Now referring to FIG. 4, an embodiment of a computer network useful for enabling a distributed digital rights management environment which may be used in conjunction with a lodestone application is shown. In brief overview, a plurality clients 113 in a plurality of networks 111a, 111b, 111n, are in communication with a plurality of supernodes. The supernodes 100, in turn are in communication with one or more central servers 110, 115, 120.

Still referring to FIG. 4, now in greater detail, a computer network useful for enabling distributed digital rights management environment uses a plurality of supernodes to handle requests from a number of clients. The clients may be organized in one or more networks 111a, 111b, 111n, which may comprise any type of network, including without limitation local area networks, wide area networks, and peer-to-peer networks. The requests handled may comprise requests to access a media file, requests to republish a media file, requests to prepurchase a given number of licenses for a media file, and requests to upload a new media file. The supernodes may be in contact with one or more servers 110, 115, 120, which service any requests which cannot be handled by a supernode.

In some embodiments, the clients may locate a supernode for communication by requesting the network address of a supernode from a centralized server. For example, a central server may maintain an index of available supernodes, and respond to client requests by providing an address of a supernode in proximity to the client making the request. In other embodiments, a client may discover a supernode via communications with peers on the network. In still other embodiments, a client may receive the address of a second supernode via communication with a first supernode. In one embodiment, a client may maintain a table of known supernodes.

In the embodiment shown, one or more of the clients 113 may participate in a peer-to-peer file sharing network. A client 113 may download a media file from a second client 113, and then send a request to a supernode for a session key which will allow the client to play the media file using a media player. The supernodes may be located and selected such that response time to the request is lesser than if all requests for a session key went to a central server.

A server 110, 115, 120 or client 113, 100 may comprise any computing device, including, without limitation, computing devices such as the ones described in FIGS. 2A and 2B. The client 113 may comprise any device having functionality for playing one or more media files, and sending and receiving information. In some embodiments, the client may comprise software and/or hardware specifically adapted for the playing of media files. In other embodiments, a client may also comprise software and/or hardware comprising a peer verification module which executes on the client. A peer verification module may be used to authenticate requests made by peers with whom a client has communicated with in the past. In one embodiment, a peer verification module may receive, from an authentication server, a request comprising a user identifier and an application identifier; determine that the received user identifier corresponds to the application identifier; and transmit a response to the server identifying the determined correspondence.

In some embodiments, the peer verification module may execute on the client transparently to the user of the client. In one embodiment, the peer verification module may comprise a background process which executes upon a network connection being established by the client. In another embodiment, the peer verification module may automatically begin executing upon startup of a media file player. In one embodiment, a media file player and a peer verification module may be packaged together for download or purchase on CD, such that installing the media file player automatically installs the peer verification module as well. In some embodiments, the media file player and the peer verification module mare share one or more processes, code, or executables.

A client may also comprise a usage monitor, which operates to monitor the amount and frequency with which the client is online. A usage monitor may also monitor the availability of a client for acting as a file server or as an authentication server.

The clients 113 may be in communication with one or more other clients 113 via peer-to-peer connections. Examples of peer-to-peer interactions may include sharing files, Internet streaming, instant messaging, electronic mail, Voice over Internet Protocol (VoIP) applications, and distributed computing. In one embodiment, a client may store one or more files in a manner such that the files are accessible by one or more other clients. This may be done using any peer-to-peer file sharing or streaming technology. In one embodiment, a number of clients may use a single web site to post links to files and other content the clients are currently sharing. In some embodiments, a client 113 may use a lodestone 150 displayed in a peer-to-peer communication application to transfer one or more files or information related to one or more files.

A supernode 100 may comprise any client or server designated to receive requests from clients 113 to access one or more media files. A supernode may also be referred to as an authentication server. In some embodiments, a supernode may comprise a client 113, with software for handling media file requests. In some embodiments, a supernode may comprise a client which has been selected to serve as a supernode 100 because of certain behavior. Examples of selection criteria for a supernode may comprise reliability thresholds, uptime thresholds, peer verification thresholds, network activity thresholds, connection bandwidth thresholds, and node location algorithms. For example, a client 113 may be elected as a supernode based on participating in a network for a given amount of time. Or, for example, a client 113 may be elected as a supernode based on stability, network speed, or having downloaded or uploaded a certain number of media files.

A supernode may comprise software or hardware which acts as an authentication server, which manages requests from clients 113 to access files and authenticates the clients and one or more users of the clients. In some embodiments, software comprising functionality for a client to perform supernode functions may be included with a media file player and a peer verification module as described above. In another embodiment, the supernode software may be downloaded by a client upon election of the client as a supernode. In one embodiment, the supernode software may execute transparently to a user of the client. In another embodiment, a user of the client may be prompted to select whether the user wishes the client to perform supernode functions.

A server, such as the servers 110, 115, 120, and the supernode 100 may comprise any computing device or devices capable of sending and receiving information. In some embodiments, a server may comprise a group of servers which act as a logical unit, such as, for example, a server farm or a number of distributed data centers with servers performing related functions. In some embodiments, two or more of servers depicted may reside on the same physical machine. In some embodiments, two or more of the servers depicted may share one or more resources including, without limitation, processors, memory, and bandwidth.

In some embodiments, a supernode may be in communication with a central license server 120. A central license server may be used as a central repository for licensing information relating to a plurality of media files. In the embodiment shown, the supernode 100 may communicate with a central license server to determine a license that applies to a particular media file. The supernode 100 may also communicate with a central license server to verify the identity of one or more clients.

In some embodiments, the supernode 100 may store information relating to license information to particular media files. In some embodiments, the supernode may store license information relating to previously requested media files, to enable subsequent requests for those media files to be processed more efficiently. In another embodiment, a supernode may receive periodic updates of licensing information relating to media files from a central license server 120. In still other embodiments, a supernode may receive updates from other supernodes 100. The supernodes and central license server or servers may use any techniques for synchronizing license information, including periodic updates, pushed updates, pulled updates, and predictive updates.

In some embodiments, a supernode may also store one or more media files. In other embodiments, a centralized content server may be provided to store media files in the system. In still another embodiment, media files may be stored via a combination of central servers, supernodes, and clients using peer-to-peer file transfer software.

In the embodiment shown, the supernode 100 is also connected to a payment processing server 115. The payment processing server 115 may comprise any server capable of processing information corresponding to transferring funds between two parties, such as for example, processing credit card charges, credit card credits, bank account withdrawals and bank account deposits. A payment processing server may comprise one or more payment modules including a secured web-service based interface to integrate with micropayment, online payment, mobile payment or legacy payment systems. In some embodiments, a payment processing server may include support for currency conversion, including conversion to one or more virtual currencies used within the system. In some embodiments, the payment processing server 115 may be used to collect revenue associated with one or more purchases of access to a media file. For example, the payment processing server 115 may receive credit card payments from players corresponding to downloading a movie. Or, for example, the payment processing server 115 may distribute funds back to a content publisher. For example, a given audio file might have an associated $1 download fee. The payment processing server 115 may collect the $1 fee from a client, and then transfer some or all of the $1 to an account held by the publisher of the audio file. In some embodiments, a payment processing server may store information relating to one or more user accounts. In these embodiments, users may deposit a given amount of money in an account and have the account deducted for purchases relating to the system.

In the embodiment shown, the game server 100 is also connected to an advertisement server 110. An advertisement server 110 may comprise any server capable of transmitting one or more advertisements. In some embodiments, an advertisement server may be used to generate targeted advertisements corresponding to a particular media file and end user.

In some embodiments, one or more of the servers discussed may comprise web servers, which may comprise any server capable of delivering content readable by a web browser including, without limitation, HTML pages, Javascript, Java applets, Ajax, XML, WML, and images. In some embodiments, the servers may receive and transmit streaming content and services.

The client 113 and the servers may be connected in any manner, and via any network or networks. For example, in some embodiments, the clients 113 may communicate directly with one or more of the supernode 100, the central license server 120, the payment processing server 115, or the advertisement server 110. Connections and networks included in the connections may comprise the Internet, local networks, web servers, file servers, routers, databases, computers, servers, network appliances, or any other computing devices capable of sending and receiving information. The network may comprise computing devices connected via cables, infrared ports, wireless signals, or any other means of connecting multiple computing devices. The network and any devices connected to the networks may communicate via any communication protocol used to communicate among or within computing devices including, without limitation, SSL, BitTorrent, HTML, XML, RDP, ICA, FTP, HTTP, SIP, XMPP (also known as Jabber), TCP, IP, UDP, IPX, SPX, NetBIOS, NetBEUI, SMB, SMTP, Ethernet, ARCNET, Fiber Distributed Data Interface (FDDI), RS232, IEEE 802.11, IEEE 802.1a, IEE 802.11b, IEEE 802.11 g and direct asynchronous connections or any combination thereof. The network may comprise mobile telephone networks utilizing any protocol or protocols used to communicate among mobile devices, including AMPS, TDMA, CDMA, GSM, GPRS or UMTS.

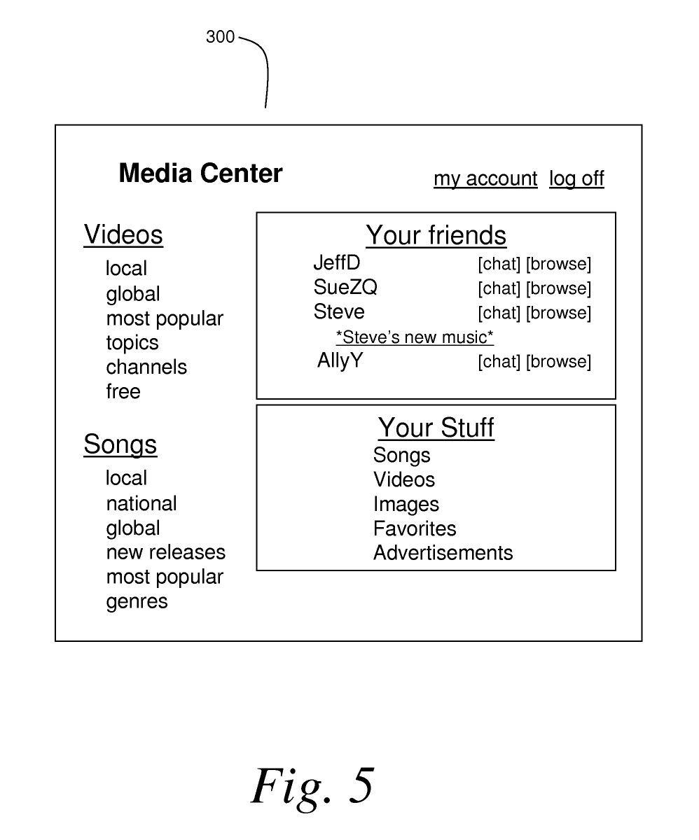

Referring now to FIG. 5, a block diagram of an example of a media file access center which may be used in conjunction with a lodestone application is shown. In brief overview, a media file access center may comprise a computer application or web page which allows a user to access media files available on a network. A media file access center may comprise means for a user to chat, share media files with, and otherwise communicate with a number of other users or peers. A media file access center 300 may also comprise means for a user to browse, download, and upload media files from one or more centralized locations.

Still referring to FIG. 5, now in greater detail, in some embodiments, a media file access center 300 may comprise a standalone application. In other embodiments, a media file access center may comprise a web site. A media file access center may be implemented using any programming and/or display languages including, without limitation, HTML, XML, WML, javascript, Java applets, Ajax, SVG, and Flash.

A media file access center 300 may comprise functionality for a user to browse media files hosted by one or more peers. In some embodiments, a user may be provided with a directory structure in which the user can browse files hosted by peers. In other embodiments, any other interface may be provided, including peer home pages, topic and keyword searches, and searching based on peer recommendations.

A media file access center 300 may also comprise functionality for searching one or more centralized locations for media files. In some embodiments, these central locations may comprise servers which store copies of media files which may also be hosted on one or more peers. In another embodiment, these central locations may comprise commercial entities which host content.

In some embodiments, a media file access center may be linked or otherwise operate in conjunction with a media file player. For example, a user may locate a media file using the media file access center, and upon selecting the media file, a media file player is launched or activated to play the selected media file. Or for example, a user may select a media file for viewing, and the media file access center may automatically deduct a fee associated with the viewing of the media file from the user's account. The media file access center may then transmit confirmation of the payment and an access key for the media file to a media file player. In other embodiments, a single application may comprise both a media file player and a media file access center.

In some embodiments, the media file access center and/or any content residing on the media file access center may be hosted by a supernode 100. In other embodiments, the media file access center and/or any content residing on the media file access center may be hosted by a centralized server.

A media file access center may be configured to work with a lodestone application such that content accesses through the media file access center can be accessed in other applications. In some embodiments, a lodestone application may be distributed with a media file access center. In other embodiments, a lodestone application may be downloaded separately from a media file access center.

For example, a user may create and/or edit a video file using the media file access center 300. The user may then distribute the created file using a number of different applications, such as e-mail, instant messaging, and VoIP applications. In each application, a lodestone application may display a lodestone allowing a user to paste either the created media file or a link to the created file. The lodestone application may apply any appropriate DRM schemes, measures, or licenses to the created media files. For example, if the created media file incorporates content requiring a per-user license, each time a user uses a lodestone to request to send the created file to another user, the lodestone application may request an appropriate license using a network shown in FIG. 4, and create a copy of the media file containing appropriate DRM information for transmission.

While the invention has been particularly shown and described with reference to specific preferred embodiments, it should be understood by those skilled in the art that various changes in form and detail may be made therein departing from the spirit and scope of the invention as defined by the appended claims.

We claim:

1. A method for displaying a lodestone application to integrate functionality of a media application in a plurality of unaffiliated application windows, the method comprising:
(a) receiving, via an operating system, a window event;
(b) determining the window event indicates activation of an application window;
(c) determining the application window corresponds to an application window for which a lodestone is configured;
(d) identifying, in response to the determinations, display configuration information for the lodestone, the display configuration information corresponding to the application window; and
(e) displaying, according to the display configuration information, the lodestone in the application window.

2. The method of claim 1, wherein the lodestone comprises a graphical icon.

3. The method of claim 1, wherein step (a) comprises registering a window event listener.

4. The method of claim 1, wherein the operating system comprises MICROSOFT WINDOWS.

5. The method of claim 1, wherein step (b) comprises determining the window event indicates a WM_ACTIVE event.

6. The method of claim 1, wherein step (c) comprises identifying at least one of: a name of a compiled class of the window, a process name of the window, or a name of a compiled class of a cursor event.

7. The method of claim 1, wherein step (c) comprises identifying at least one of: a main window class name, a first child window class name, or second child window class name.

8. The method of claim 1, wherein step (c) comprises comparing a class name associated with the window event to a list of allowed application windows.

9. The method of claim 1, wherein step (d) comprises identifying window position coordinates for the lodestone.

10. The method of claim 1, wherein step (d) comprises identifying a display color for the lodestone.

11. The method of claim 1, wherein step (d) comprises identifying a background color of the application window.

12. The method of claim 1, further comprising ceasing to display a lodestone displayed in a second application window.

13. The method of claim 1, further comprising pasting, in response to a user interaction with the lodestone, data from a second application into the application window.

14. The method of claim 13, wherein the second application comprises a media distribution application.

15. The method of claim 13, wherein the pasted data comprises a URL.

16. The method of claim 1, further comprising displaying, via the lodestone, information identifying at least one media file.

17. The method of claim 1, further comprising displaying, via the lodestone, information identifying at least one recently accessed media file.

18. The method of claim 1, wherein the application window comprises an electronic mail application.

19. The method of claim 1, wherein the application window comprises an instant messaging window.

20. The method of claim 1, wherein the application window comprises a web browser.

21. The method of claim 1, wherein the application window corresponds to a first application, the first application unaffiliated with a second application corresponding to the lodestone.

22. A computer implemented system for displaying a lodestone application to integrate functionality of a media application in a plurality of unaffiliated application windows, the system comprising:
means for receiving, via an operating system, a window event;
means for determining the window event indicates activation of an application window;
means for determining the window event corresponds to an application window for which a lodestone is configured;
means for identifying, in response to the determinations, display configuration information for the lodestone, the display configuration information corresponding to the application window; and
means for displaying, according to the display configuration information, the lodestone in the application window.

23. The system of claim 22, wherein the lodestone comprises a graphical icon.

24. The system of claim 22, wherein the system comprises means for registering a window event listener.

25. The system of claim 22, wherein the operating system comprises MICROSOFT WINDOWS.

26. The system of claim 22, wherein the system comprises means for determining the window event indicates a WM_ACTIVE event.

27. The system of claim 22, wherein the system comprises means for identifying at least one of: a name of a compiled class of the window, a process name of the window, or a name of a compiled class of a cursor event.

28. The system of claim 22, wherein the system comprises means for identifying at least one of: a main window class name, a first child window class name, or second child window class name.

29. The system of claim 22, wherein the system comprises means for comparing a class name associated with the window event to a list of allowed application windows.

30. The system of claim 22, wherein the system comprises means for identifying window position coordinates for the lodestone.

31. The system of claim 22, wherein the system comprises means for identifying a display color for the lodestone.

32. The system of claim 22, wherein the system comprises means for identifying a background color of the application window.

33. The system of claim 22, wherein the system comprises means for ceasing to display a lodestone displayed in a second application window.

34. The system of claim 22, wherein the system comprises means for pasting, in response to a user interaction with the lodestone, data from a second application into the application window.

35. The system of claim 34, wherein the second application comprises a media distribution application.

36. The system of claim 34, wherein the pasted data comprises a URL.

37. The system of claim 22, wherein the system comprises means for displaying, via the lodestone, information identifying at least one media file.

38. The system of claim 22, wherein the system comprises means for displaying, via the lodestone, information identifying at least one recently accessed media file.

39. The system of claim 22, wherein the application window comprises an electronic mail application.

40. The system of claim 22, wherein the application window comprises an instant messaging window.

41. The system of claim 22, wherein the application window comprises a web browser.

42. The system of claim 22, wherein the application window corresponds to a first application, the first application unaffiliated with a second application corresponding to the lodestone.
